(19) United States
(12) Patent Application Publication
(10) Pub. No.: US 2019/0239639 A1
(43) Pub. Date: Aug. 8, 2019

(54) COMPACT SHELF ASSEMBLY

(71) Applicant: Keter Plastic Ltd., Herzelyia (IL)

(72) Inventor: Yaron BRUNNER, Kibbutz Gvat (IL)

(73) Assignee: Keter Plastic Ltd., Herzelyia (IL)

(21) Appl. No.: 16/264,849

(22) Filed: Feb. 1, 2019

(30) Foreign Application Priority Data
Feb. 4, 2018 (IL) 257349

(51) Int. Cl. A47B 47/00; A47B 47/04

(52) U.S. Cl. CPC A47B 47/0083; A47B 47/045

(57) ABSTRACT

Shelving systems, in particular employing modular design, configured in assembled configuration and nested configuration. This includes a plurality of shelves and posts to maintain the shelves vertically spaced from one another at a fixed distance. Each shelf has a substantially flat panel and one or more depressions including first apertures vertically spaced from the panel. Each aperture to receive a first post end. The shelf assembly includes one or more shelf caps, secured above the depressions, each including one or more second apertures disposed, when its corresponding shelf cap is secured to the shelf, to lie over a corresponding first aperture. In assembled configuration the posts are vertically arranged such first and second ends of adjoining posts constitute pairs adjacent one another, one end of each of the pairs coupled with a first aperture, and one end of each of the pairs coupled with its corresponding second aperture.

### TECHNOLOGICAL FIELD

The present disclosure relates to shelving systems, and in particular to shelving systems employing a modular design.

### BACKGROUND

Modular shelving systems are known for storing and supporting items and products of all types. Typically, modular shelving systems contain a number of components that can be easily assembled to conform to a customer's needs. They may include modular components such as shelves, vertical posts, etc. Such shelf systems are often provided in an unassembled state, for assembly by a user on-site.

### SUMMARY

According to one aspect of the present disclosure, there is provided a shelf assembly configured to be selectively arranged in an assembled configuration and a nested configuration. The shelf assembly comprises a plurality of shelves and a plurality of posts, the posts comprising first and second ends and are configured to maintain the shelves vertically spaced from one another at a fixed distance. Each shelf is formed with a substantially flat panel and one or more depressions comprising a plurality of first apertures disposed vertically spaced from the panel, each aperture being configured to receive therein a first end of one of the posts. The shelf assembly further comprises one or more shelf caps secured above the depressions, each of the shelf caps comprising one or more second apertures that are disposed, when its corresponding shelf cap is secured to the shelf, so as to lie in registration over a corresponding one of the first apertures. In the assembled configuration, the posts are vertically arranged (e.g., in several vertical arrangements), such first and second ends of adjoining posts constitute pairs being adjacent one another, one end of each of the pairs being coupled with one of the first apertures, and one end of each of the pairs being coupled with its corresponding second aperture.

The first and second ends may be configured to couple with one another. The second end may be snuggly receivable within the first end.

Each end of the posts coupled with a first or second aperture may be snuggly received therewithin. The first end of each pair may be coupled with the first and second apertures.

The shelf may define a storage space below the panel and between the depressions, the shelves and posts being configured such that the storage space of one of the shelves and the depressions of one of the shelves fully accommodate all of the posts in the nested configuration.

The storage space and depressions accommodating the posts may be defined by different shelves.

The shelves may be configured such that the storage space of one shelf fully accommodates all of the posts.

Each of the shelf caps may comprise two or more of the second apertures.

Each of the depressions may extend along a margin of the shelf.

Each of the shelf caps may completely close a respective depression.

In the assembled configuration thereof, the first and second ends of the posts may be disposed within the depressions.

Each of the first and second ends of the posts may be demarcated by an at least partially circumferential ridge, being larger than the aperture, thereby limiting the extent to which the end may be inserted through a corresponding aperture.

The shelf assembly may further comprise a plurality of legs, each configured for being received within at least a first aperture of a lowermost of the shelves when the shelf assembly is in its assembled configuration.

Each of the legs may comprise an end configured for coupling with one of the ends of the posts. Each of the legs may be configured for snug receipt with the one of the ends of the posts.

The storage space of the one of the shelves and the depressions of the one of the shelves may additionally fully accommodate the legs.

The shelf assembly may further comprise a plurality of post caps, each configured for being received within at least a second aperture of a topmost of the shelves when the shelf assembly is in its assembled configuration.

Each of the post caps may be configured for coupling with one of the ends of the posts. Each of the post caps may be configured for snug receipt with the one of the ends of the posts.

The storage space of the one of the shelves and the depressions of the one of the shelves may additionally fully accommodate the post caps.

The posts may have a rectangular cross-section.

The posts may have a triangular cross-section.

In the nested configuration of the shelf assembly, pairs of the posts may be arranged such that the second end of one of the posts in each pair is snuggly received within the first end of the other of the posts in the pair.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1A is a perspective view of an example of a shelf assembly according to the presently disclosed subject matter, in an assembled configuration thereof;

FIG. 1B is a partially exploded view of the shelf assembly illustrated in FIG. 1A;

FIG. 2 is a perspective view of the shelf assembly illustrated in FIG. 1A, in a nested configuration thereof;

FIG. 3A is a perspective view of a shelf of the shelf assembly illustrated in FIGS. 1A through 2;

FIG. 3B is a cross-sectional view taken along line in FIG. 3A;

FIG. 3C is a top view of the shelf illustrated in FIG. 3A;

FIG. 4 is a perspective view of a shelf cap of the shelf assembly illustrated in FIGS. 1A through 2;

FIG. 5 is a perspective view of a post of the shelf assembly illustrated in FIGS. 1A through 2;

FIG. 6 is a perspective view of a leg of the shelf assembly illustrated in FIGS. 1A through 2;

FIG. 7 is a perspective view of a post cap of the shelf assembly illustrated in FIGS. 1A through 2;

FIG. 8 is a partial perspective view taken along line VIII-VIII in FIG. 8;

FIGS. 9 and 10 are, respectively, perspective and side exploded views of the shelf assembly in its nested configuration;

FIG. 11 is a bottom perspective view of the shelf assembly in its nested configuration;

FIG. 12 is a perspective view of another example of a shelf assembly according to the presently disclosed subject matter, in an assembled configuration thereof;

FIG. 13 is a perspective view of the shelf assembly illustrated in FIG. 12, in a nested configuration thereof and

FIG. 14 is an exploded view of the shelf assembly as illustrated in FIG. 13.

### DETAILED DESCRIPTION

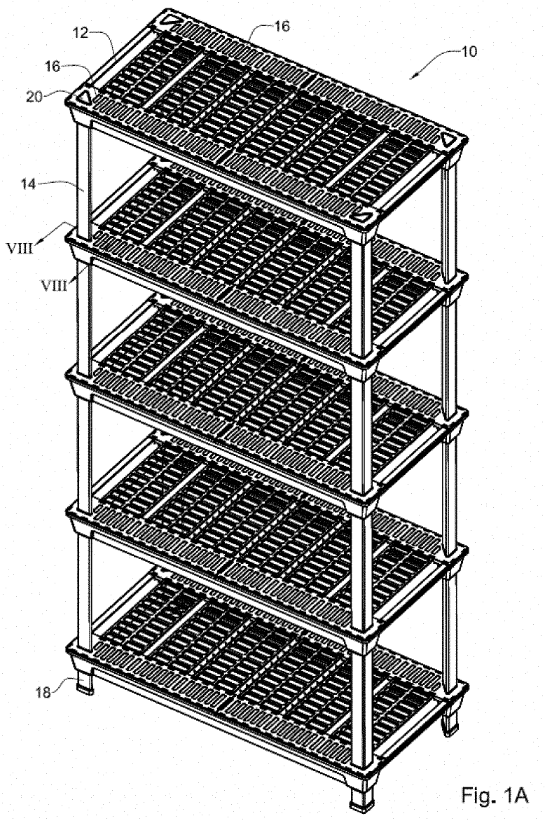

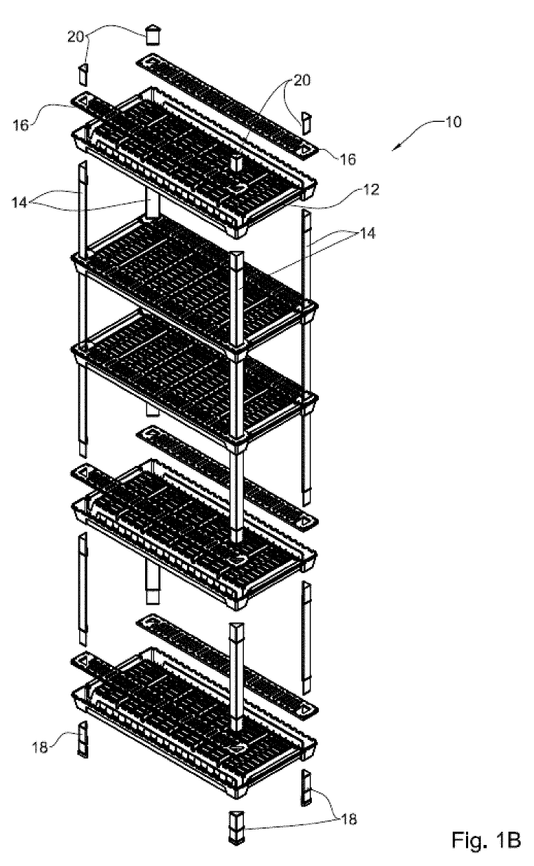

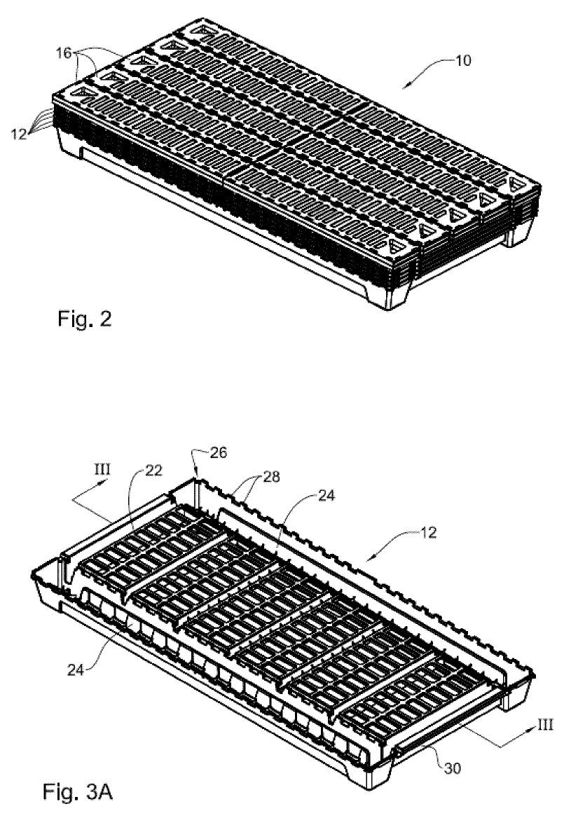

As illustrated in FIGS. 1A, 1B, and 2, there is provided a shelf assembly, which is generally indicated at 10. The shelf assembly 10 may be arranged in an assembled configuration (as illustrated in FIGS. 1A and 1B) to form a shelving unit, and a nested configuration (as illustrated in FIG. 2), for example to facilitate convenient storage, transport, etc., thereof. The shelf assembly made be made of any one or more suitable materials, including, but not limited to, plastic (e.g. injection-molded plastic).

The shelf assembly 10 comprises a plurality of shelves 12, vertical posts 14, horizontal shelf caps 16, legs 18, and post caps 20. According to the non-limiting example described herein, the shelf assembly 10 comprises four posts 14 per each shelf 12 provided less one (i.e., for five shelves provided, four posts are provided per each of four shelves), two shelf caps 16 per each shelf provided, and four each of legs 18 and post caps 20. Accordingly, the presently disclosed example of the shelf assembly 10 comprises five shelves 12, sixteen posts 14, ten shelf caps 16, four legs 18, and four post caps 20. As will be appreciated, the shelf assembly may comprise a plurality of shelves, e.g. 2, 3, 4, 5, 6, 7, 8 or even more, and the number of accompanying components will then be included in accordance with the number of shelves in the shelf assembly.

It will also be appreciated that in the present disclosure, terms indicating direction and/or orientation, such as up, down, front, rear, horizontal, vertical, etc., are used with respect to the example illustrated in and described with reference to FIG. 1A (i.e., in the assembled configuration of the shelf assembly) and should not be construed as limiting, e.g., to a particular orientation, nor to excluding orientations relevant to the nested configuration.

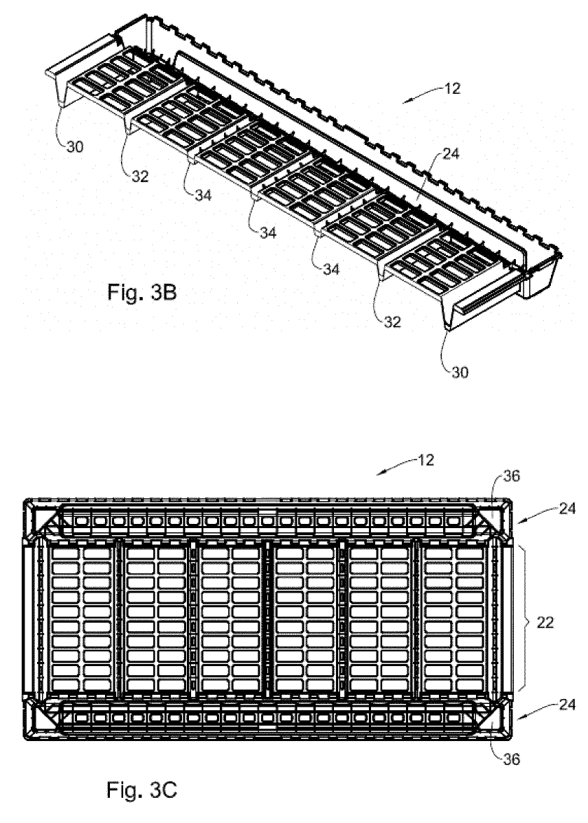

As illustrated in FIG. 3A, each of the shelves 12 comprises a panel 22 comprising a flat upper surface and being disposed between two horizontally-extending depressions 24, one running along each of two parallel margins of the shelf. It will be appreciated that the term flat as used herein is used in its broadest sense, i.e., as generally conforming to a level reference plane, but not excluding deviations in the panel such as apertures, projections, concavities, etc.

A first snapping arrangement 26 is provided on the rim of each of the depressions 24, configured to cooperate with one of the shelf caps 16 for securing it thereto, as will be described below. For example, each first snapping arrangement 26 may comprise a plurality of snapping elements 28 (e.g., formed as upwardly-protruding tabs) along the rim of the depression 24.

Each shelf 12 is formed as a shaped sheet of material, for example plastic. Accordingly, it has a substantially constant thickness, facilitating efficient stacking thereof, i.e., reducing the height of a stack of nested shelves 12. As best seen in FIG. 3B, each shelf 12 may be formed with two downwardly-projecting sidewalls 30 extending between the depressions 24 and two downwardly-projecting ribs 32 extending transversely between the depressions. Each shelf 12 may be further formed with a plurality of downwardly-projecting support bars 34, for example disposed between, and being shorter than, the ribs 32.

As best seen in FIG. 3C, each corner of the shelf 12 is provided with a through-going aperture 36, configured for snug receipt therethrough of an end of one of the posts 14, as will be described below.

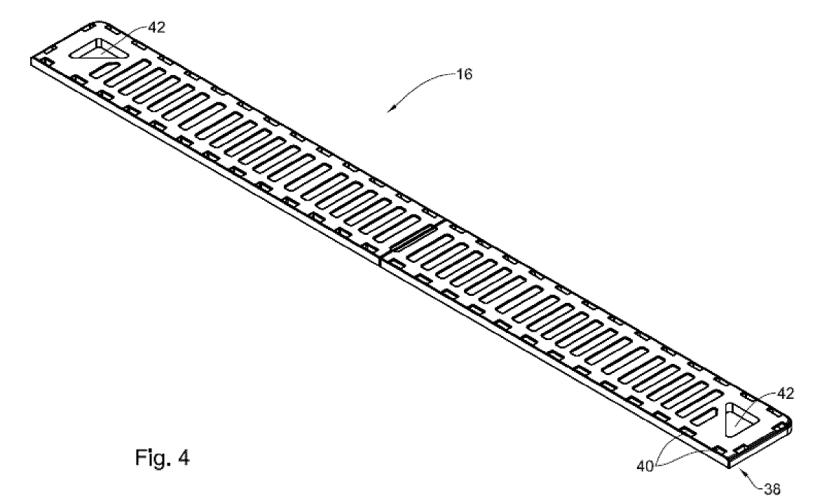

Each of the shelf caps 16 is formed so as to lie in registration over one of the depressions 24 of the shelves 12, e.g., completely covering it. As illustrated in FIG. 4, it comprises a second snapping arrangement 38 configured for cooperating with one of the first snapping arrangements 26 of the shelves 12 for being secured thereto. For example, it may comprise a plurality of apertures 40, each configured to receive, e.g., snappingly, one of the snapping elements of a corresponding snapping arrangement 26.

A through-going aperture 42, configured for snug receipt therethrough of an end of one of the posts 14, as will be described below, is formed at each end of each of the shelf cap 16. The apertures 42 are formed such that when the shelf cap 16 is secured to a shelf 12 as described herein, they lie in registration directly above the apertures 36 formed in the shelf.

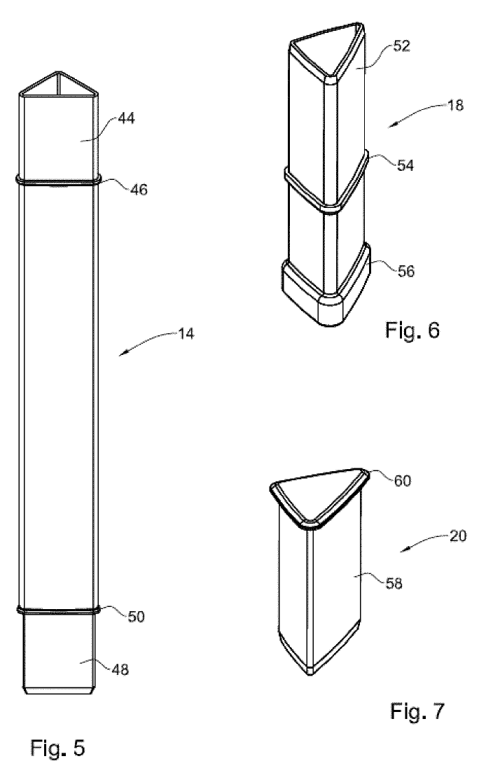

As illustrated in FIG. 5, each of the posts 14 may be formed as an optionally hollow, cylindrical member. According to some examples, the post 14 has a triangular lateral cross-section, for example forming a right triangle. A top end 44 of the post 14 is demarcated by a circumferential upper ridge 46, and a bottom end 48 of the post is demarcated by a circumferential lower ridge 50. The bottom end 48 may have a smaller cross-section than that of the top end 44, for example being sized so as to fit snuggly therein.

As illustrated in FIG. 6, each of the legs 18 has a cross-section similar to that of the posts 14. A top end 52 of the leg 18 is demarcated by a leg ridge 54. The top end 52 of the leg 18 has a cross-section configured to snuggly receive therein a bottom end 48 of a post 14. A base 56, for example comprising a circumferential bulge, may be provided at the bottom of the leg 18, e.g., to increase the stability of the shelf assembly 10 when in its assembled configuration.

As illustrated in FIG. 7, each of the post caps 20 comprises a main portion 58 designed similarly to the bottom end 48 of the posts 14, i.e., having a cross-section configured to fit snuggly within the top end 44 of a post 14. The post cap 20 may further comprise a cover 60 constituting a top surface thereof. The circumference of the cover 60 may have a similar size to that of the lower ridge 50 of the posts 14.

It will be appreciated that the posts 14 may be provided such that the top end 44 has a smaller cross-section than that of the bottom end 48 so as to fit snuggly therewithin, with other elements of the shelf assembly, e.g., the legs 18 and post caps 20, being suitable designed, mutatis mutandis.

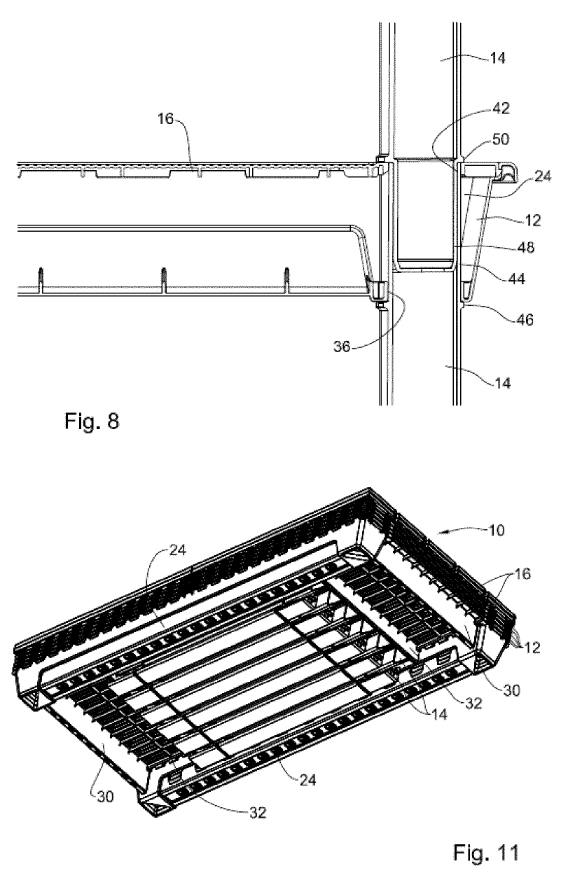

The elements described above may be arranged to form the assembled configuration of the shelf assembly 10 as follow:
Two of the shelf caps 16 are secured to each shelf 12, for example employing the complementary first and second snapping arrangements 26, 36 as described above.
For each shelf 12, with the exclusion of the lowermost one, four posts 14 are inserted through the apertures 36, 42 formed, respectively, in the shelf and shelf cap 16 secured thereto. As illustrated in FIG. 8, the top end 44 of each of the posts is inserted upwardly through the apertures 36, 42, until the upper ridge 46 abuts the bottom of the shelf 12 adjacent the aperture 36. When the post 14 is fully inserted, the distal rim 44a of the top ends 44 thereof may be flush with the top surface of the shelf cap 16.
In the lowermost shelf 12, the four legs 18 are inserted through the apertures 36, 42, similar to the way the top ends 44 of the posts 14 are inserted into the corresponding apertures of the other shelves, as described above with reference to and illustrated in FIG. 8, with the leg ridge 54 abutting the bottom of the shelf
The bottom ends 48 of the posts 14 are inserted downwardly through the apertures 36 formed in the shelves 12, and snuggly received within the top ends 44 of the posts previously inserted therethrough (in the case of the bottom shelf, within the top ends 52 of the legs 18 previously inserted therethrough). As illustrated in FIG. 8, the lower ridge 50 abuts the top of the shelf cap 12 adjacent the aperture 42.
The post caps 20 are similarly inserted through the apertures 36 formed in the top shelf 12, and snuggly received within top ends 44 of the posts 14 previously inserted therethrough, similar to the way the bottom ends 48 of the posts 14 are inserted into the corresponding apertures of the other shelves, as described above, with the covers 60 thereof abutting the top of the shelf, and the main portion 58 snuggly received within the top ends 44 of the posts.

Reverting to FIG. 2, the shelf assembly 10 may be put together in a nested configuration. Typically, the shelf assembly 10 is packaged in the nested configuration for retail sale.

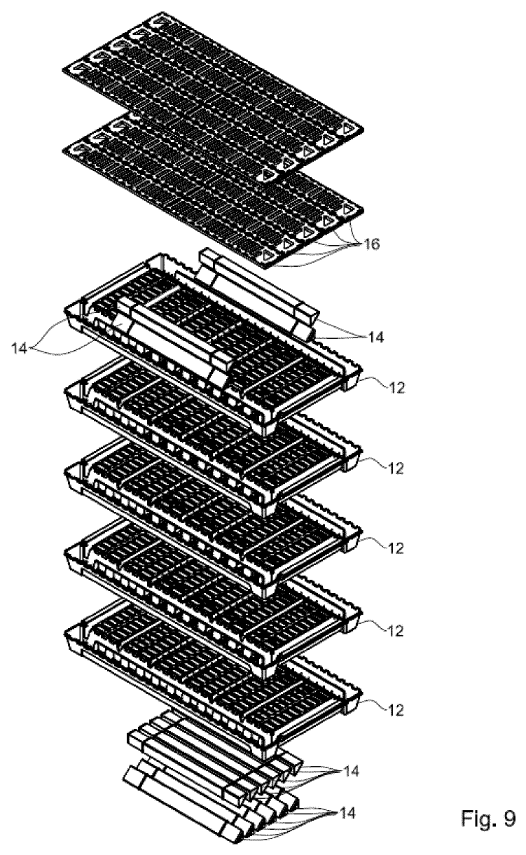

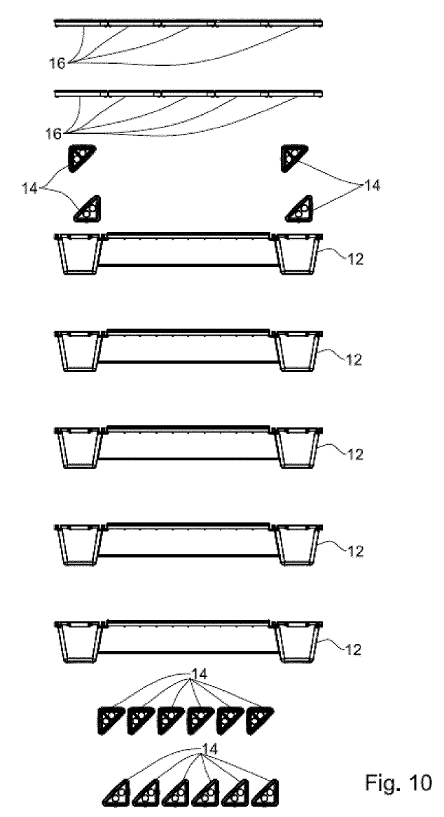

As illustrated in FIGS. 9 and 10, in the nested configuration, the shelves 12 are nested one within another to form a compact stack, as described above. Pairs of posts 14 are aligned with one another, with the long side of each facing each other, and the top ends 44 adjacent the bottom ends 48. As best illustrated in FIG. 11, twelve of the posts 14 (i.e., six pairs) may be disposed below the bottommost nested shelf 12, between the depressions 24 and between the downwardly-projecting ribs 32. It will be appreciated that the posts 14 are fully accommodated within the space under the panel 22 and between the depressions 24, i.e., they do not extend farther vertically from the bottom of the panel than do the depressions, and they do not extend horizontally beyond the shelf. The legs 18 and post caps 20 (not illustrated in FIGS. 9 through 11) may be aligned similar to the way the posts 14, and accommodated between the ribs 32 and sidewalls 30. Each of the other pairs of posts 14 may be fully accommodated within one of the depressions 24 (i.e., not extending above the level of the flat upper surface of the panel 22) of the topmost nested shelf 12. The shelf caps 16 are arranged in two layers over the stack of nested shelves 12.

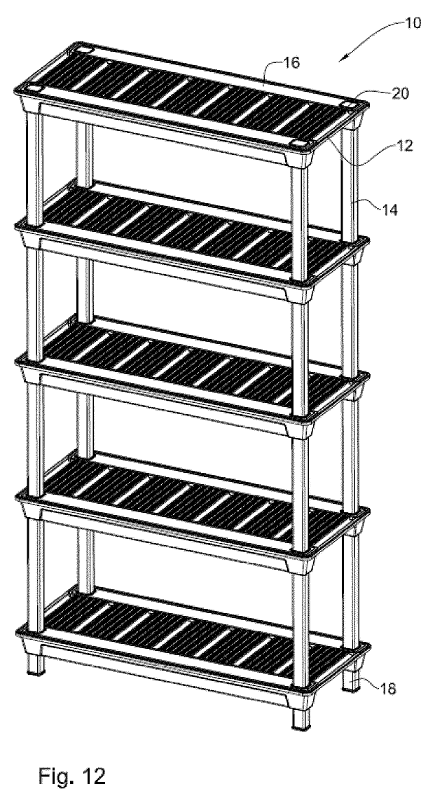

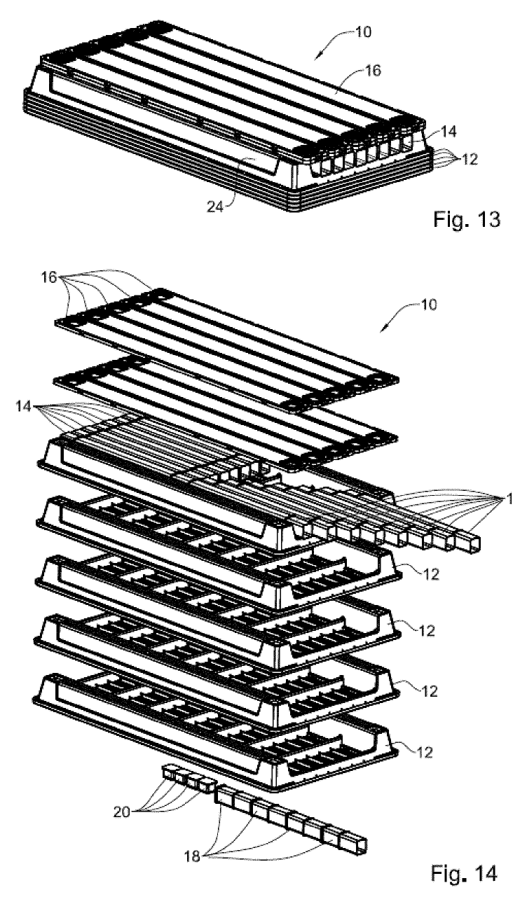

It will be appreciated that the example described above with reference to and illustrated in FIGS. 1A through 1I may be modified without departing from the scope of the presently disclosed subject matter, mutatis mutandis. FIGS. 12 through 14 illustrates an example of a shelf assembly 10 with several modifications, any one or more of which may be provided.

According to some examples, the posts 14 may be provided similar to as described above, for example with reference to and illustrated in FIG. 5, but having a rectangular, e.g., square, cross-section. The apertures 36, 42 formed, respectively, in the shelves 12 and shelf caps 16 are similarly formed with a rectangular cross-section.

According to other examples, in the nested configuration, the shelves 12 are nested one within another to form a compact stack, as described above, and arranged upside-down. Pairs of posts 14 are coupled with the bottom end 48 of one received within the top end of the other. The eight pairs of posts 14 (i.e., all sixteen posts) are disposed below the flat panel of the topmost nested shelf 12, between the depressions 24 thereof. The legs 18 and post caps 20 are accommodated in one or both of the depressions 24 of the bottommost shelf 12.

Those skilled in the art to which this invention pertains will readily appreciate that numerous changes, variations, and modifications can be made without departing from the scope of the presently disclosed subject matter, mutatis mutandis.

1. A shelf assembly configured to be selectively arranged in an assembled configuration and a nested configuration, the shelf assembly comprising a plurality of shelves and a plurality of posts comprising first and second ends and being configured to maintain the shelves vertically spaced from one another at a fixed distance;
each shelf being formed with a substantially flat panel and one or more depressions comprising a plurality of first apertures disposed vertically spaced from said panel, each aperture being configured to receive therein a first end of one of the posts;
the shelf assembly further comprising one or more shelf caps secured above the depressions, each of the shelf caps comprising one or more second apertures being disposed, when its corresponding shelf cap is secured to the shelf, so as to lie in registration over a corresponding one of the first apertures;
wherein in the assembled configuration the posts are vertically arranged such first and second ends of adjoining posts constitute pairs being adjacent one another, one end of each of the pairs being coupled with one of the first apertures, and one end of each of the pairs being coupled with its corresponding second aperture.

2. The shelf assembly of claim 1, wherein said first and second ends are configured to couple with one another.

3. The shelf assembly of claim 2, wherein the second end is snuggly receivable within said first end.

4. The shelf assembly of claim 1, wherein each end of the posts coupled with a first or second aperture is snuggly received therewithin.

5. The shelf assembly of claim 1, wherein the first end of each pair is coupled with the first and second apertures.

6. The shelf assembly of claim 1, wherein a storage space is defined below the panel and between the depressions, the shelves and posts being configured such that the storage space of one of the shelves and the depressions of one of the shelves fully accommodate all of the posts in the nested configuration.

7. The shelf assembly of claim 1, wherein each of the shelf caps comprises two or more of the second apertures.

8. The shelf assembly of claim 1, wherein each of the depressions extends along a margin of the shelf.

9. The shelf assembly of claim 1, wherein each of the shelf caps completely closes a respective depression.

10. The shelf assembly of claim 1, wherein, in the assembled configuration thereof, the first and second ends of the posts are disposed within the depressions.

11. The shelf assembly of claim 10, each of the first and second ends of the posts being demarcated by an at least partially circumferential ridge, being larger than the aperture, thereby limiting the extent to which the end may be inserted through a corresponding aperture.

12. The shelf assembly of claim 1, further comprising a plurality of legs, each configured for being received within at least a first aperture of a lower-most of the shelves when the shelf assembly is in its assembled configuration.

13. The shelf assembly of claim 12, each of the legs comprising an end configured for coupling with one of the ends of the posts.

14. The shelf assembly of claim 13, wherein each of the legs is configured for snug receipt with the one of said ends of the posts.

15. The shelf assembly of claim 12, wherein a storage space is defined below the panel and between the depressions, the shelves and posts being configured such that the storage space of one of the shelves and the depressions of one of the shelves fully accommodate all of the posts in the nested configuration, and wherein the storage space of the one of the shelves and the depressions of the one of the shelves additionally fully accommodates said legs.

16. The shelf assembly of claim 1, further comprising a plurality of post caps, each configured for being received within at least a second aperture of a top-most of the shelves when the shelf assembly is in its assembled configuration.

17. The shelf assembly of claim 16, each of the post caps being configured for coupling with one of the ends of the posts.

18. The shelf assembly of claim 17, wherein each of the post caps is configured for snug receipt with said one of the ends of the posts.

19. The shelf assembly of claim 16, wherein a storage space is defined below the panel and between the depressions, the shelves and posts being configured such that the storage space of one of the shelves and the depressions of one of the shelves fully accommodate all of the posts in the nested configuration, and wherein the storage space of the one of the shelves and said depressions of the one of the shelves additionally fully accommodates the post caps.

20. The shelf assembly of claim 1, wherein, in the nested configuration thereof, pairs of said posts are arranged such that the second end of one of the posts in each pair is snuggly received within the first end of the other of the posts in the pair.
